(19) United States
(12) Patent Application Publication
(10) Pub. No.: US 2013/0093119 A1
(43) Pub. Date: Apr. 18, 2013

(54) PROCESSES FOR PRODUCING THERMOSTABLE POLYHYDROXYALKANOATE AND PRODUCTS PRODUCED THEREFROM

(71) Applicant: Eric C. Hagberg, Decatur, IL (US)

(72) Inventor: Eric C. Hagberg, Decatur, IL (US)

(73) Assignee: Archer Daniels Midland Company, Decatur, IL (US)

(21) Appl. No.: 13/703,391

(22) PCT Filed: Jun. 20, 2011
(86) PCT No.: PCT/US11/41027

§ 371 Date: Dec. 11, 2012

Related U.S. Application Data
(60) Provisional application No. 61/360,062, filed on Jun. 30, 2010.

(51) Int. Cl. C08K 5/092

(52) U.S. Cl. CPC C08K 5/092
USPC 264/328.17; 524/320

(57) ABSTRACT

Compositions comprising polyhydroxyalkanoate with improved thermostability are disclosed. Processes for producing thermostable polyhydroxyalkanoates with acids having a pKa of between 3-10 are further disclosed, as well as uses of such thermostable polyhydroxyalkanoates.

### TECHNICAL FIELD

The present invention relates generally to the field of biodegradable polymers. More specifically, it relates to polyhydroxyalkanoate polymers and methods for their production and use.

### BACKGROUND

The development and use of biodegradable polymers has been aimed at reducing the amount of plastic waste accumulation and benefits from the fact that such biodegradable polymers are made from renewable resources. However, many of these biodegradable polymers have certain undesirable chemical and physical properties that typically make most of them amenable to single, short use applications such as in packaging, personal hygiene, garbage bags and others. These applications are poorly suited for recycling, but are well suited for biodegradation through composting.

The biodegradable polymer PHA (polyhydroxyalkanoate) is a promising biodegradable plastic since it has similar properties to polypropylene in that it can be processed the same way and has the same wide application range. However, PHAs suffer from the drawback that they are thermosensitive. Such thermosensitivity results in the PHA polymer being degraded at elevated temperatures and makes the PHA polymer difficult to melt process since it must be processed at about 180° C. However, since this temperature is above the decomposition temperature of PHA, the PHA will undergo thermolysis that causes the molecular weight of the PHA to decrease at the elevated temperature for a period of time. The thermostability of the PHA can be assayed by measuring the molecular weight of the PHA.

Previous attempts to improve the thermostability of PHAs include the use of lactones and lactams to crosslink the polymer or reacting the PHA with acetic anhydride and capping terminal hydroxyl groups of the PHA. However, these attempts chemically and/or physically modify the PHAs.

U.S. Pat. No. 7,208,535 gives an overview of thermostability in PHAs and discloses the use of phosphorous-containing compounds, oxides, hydroxides, or carboxylic acid salts of metals from Groups I to V of the Periodic Table as thermal stabilizers for PHA.

Thus, what is needed is an improved way to increase the thermostability of PHAs.

### SUMMARY OF THE INVENTION

In one embodiment, a composition comprises a polyhydroxyalkanoate and an acid having a pKa of between 3-10, wherein the acid is dispersed in the polyhydroxyalkanoate.

In another embodiment, a process for producing a product comprises mixing a polyhydroxyalkanoate with an acid having a pKa of between 3-10.

In an additional embodiment, a process for producing a product, comprises injecting a melted polyhydroxyalkanoate homogenized with an acid into a mold, collecting any polyhydroxyalkanoate homogenized with the acid from outside the mold, and melting the collected polyhydroxyalkanoate homogenized with the acid.

### BRIEF DESCRIPTION OF THE DRAWINGS

FIG. 1 illustrates a TGA file for PHA with 1% citric acid and PHA without citric acid.

FIG. 2 shows a TGA file for PHA by itself and with varying concentrations of citric acid at 165° C.

FIG. 3 depicts a TGA file for PHA by itself and with varying concentrations of citric acid at 185° C.

FIG. 4 is scanning TGA at 10° C./min for PHA by itself and with varying concentrations of citric acid.

FIG. 5 is the scanning TGA of FIG. 4 at a smaller temperature range.

### DETAILED DESCRIPTION OF THE INVENTION

It was found that the caustic digestion of PHA resulted in a product that was primarily crotonic acid, which is a product of the thermolysis of PHA. It was also found that the strong acid digestion of PHA resulted in a product that was primarily 3-hydroxybutyric acid. Based on these findings, it was found that the presence of a weak acid, with a high enough pKa that would not promote the hydrolysis of the ester, reduced the tendency of PHA to undergo thermolysis.

Accordingly, in each of its various embodiments, the present invention discloses processes for producing PHAs with improved thermostability as well as the products produced therefrom. By enhancing the thermostability of the PHAs, the present invention also broadens the possible applications for PHA polymers. In another embodiment, methods that can be used to make and use thermostable PHA pellets, films and other forms of thermostable PHA of the present invention are disclosed in U.S. Pat. No. 7,208,535, the contents of the entirety of which is incorporated herein by this reference.

One embodiment of the present invention includes a composition comprising a PHA and an acid having a pKa of between 3-10, wherein the acid is dispersed in the PHA. The acid may be present in an amount of between 0.01-10% by weight. The presence of the acid being dispersed in the PHA improves the thermostability of the PHA such that upon exposure of a composition including the PHA and acid to increased temperature, the molecular weight of the PHA in the composition comprising the PHA and the acid decreases at a slower rate as compared to a PHA without the acid dispersed therein. The presence of the acid in the PHA also improves the thermal stability of the PHA.

Increasing the thermostability of the PHA will make a biodegradable plastic produced with the PHA of the present invention more amenable to processing techniques used with plastics including, but not limited to, melt compounding, extrusion, melt extrusion, molding, injection molding, coating, spinning, casting, and/or calendaring operations.

A biodegradable plastic containing the PHA of the present invention may be used to produce various products including, without limitation, films, coatings, fibers, pellets, powders, or others. Such products may be ultimately processed into consumer products.

In one embodiment, an acid that may be used to increase the thermostability of MIAs includes an acid having a pKa of 3-10. In another embodiment, the acid is selected from the group consisting of citric acid, polyacrylic acid, stearic acid, palmitic acid, lactic acid, a derivative of any thereof and combinations of any thereof.

A process used to produce a biodegradable plastic of the present invention includes mixing a PHA with an acid having a pKa of between 3-10. In one embodiment, the mixing may comprise homogenizing the PHA with the acid. In another embodiment, the mixing may comprise combining a powdered PHA with the acid in a solvent in order to homogenize the acid with the PHA. The solvent may be subsequently removed. In a further embodiment, a film comprising the PHA and the acid may be cast. Melt compounding or melt extruding may also be used to mix the PHA with the acid, wherein the compounding or extruding is performed at a temperature above the melting point of the PHA. The PHA and the acid may also be formed into a pellet or powder.

The invention is further explained by use of the following exemplary embodiments.

### Example 1

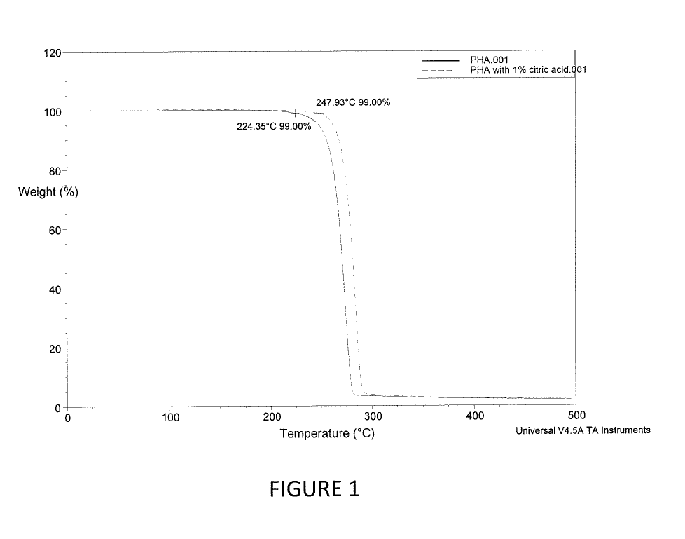

Acid functionality as a stabilizer for PHA. About 1 gram of PHA powder was added to a scintillation vial. About 0.01 grams of citric acid was dissolved in 0.1 ml of water. The citric acid in water was added dropwise with shaking to the PHA powder. The mixture was stirred with a metal spatula to evenly distribute the citric acid on the surface of the particles of the PHA powder. The scintillation vial was placed in an 80° C. vacuum over 2 hours to remove the water. The PHA powder with the citric acid was analyzed by thermogravimetric analysis (TGA) and compared to a PHA powder without citric acid analyzed by thermogravimetric analysis (TGA). The PHA with the 1% citric acid exhibited a 23° C. increase in thermal stability as measured by the 99% weight loss temperature as shown in FIG. 1.

### Example 2

Citric acid as a thermal stabilizer for PHA. 1 gram of citric acid was dissolved in 2 ml of methanol and added to 5% solutions of PHA in chloroform (CHCl₃) as outlined in Table 1. Films were cast with the compositions of Table 1 to provide homogenous samples for testing.

TABLE 1

| Sample | Description | | Amounts | Citric solution | |
|---|---|---|---|---|---|
| 80-1 | 10% | citric acid | 1 g of PHA | 200 μl | 0.5 g citric acid/ |
| | | | | | ml of methanol |
| 80-2 | 1.5% | citric acid | 1 g of PHA | 30 μl | 0.5 g citric acid/ |
| | | | | | ml of methanol |
| 80-3 | 1.0% | citric acid | 1 g of PHA | 20 μl | 0.5 g citric acid/ |
| | | | | | ml of methanol |
| 80-4 | 0.5% | citric acid | 1 g of PHA | 10 μl | 0.5 g citric acid/ |
| | | | | | ml of methanol |
| 80-5 | 0.1% | citric acid | 1 g of PHA | 2 μl | 0.5 g citric acid/ |
| | | | | | ml of methanol |
| 80-6 | 0% | citric acid | 1 g of PHA | 0 μl | 0.5 g citric acid/ |
| | | | | | ml of methanol |

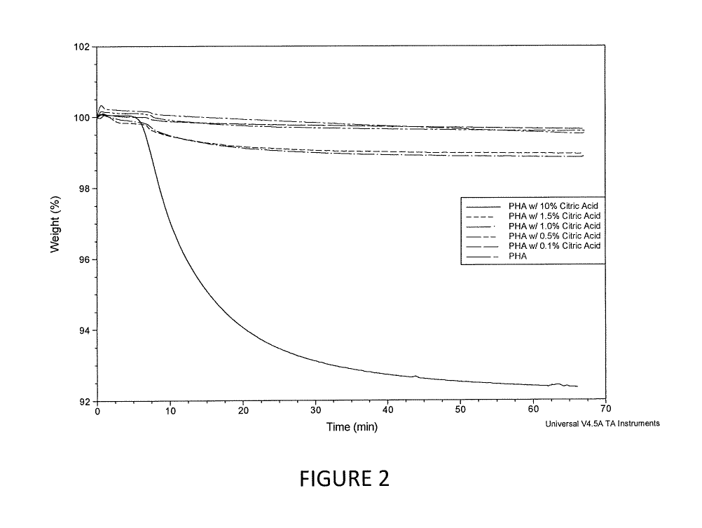

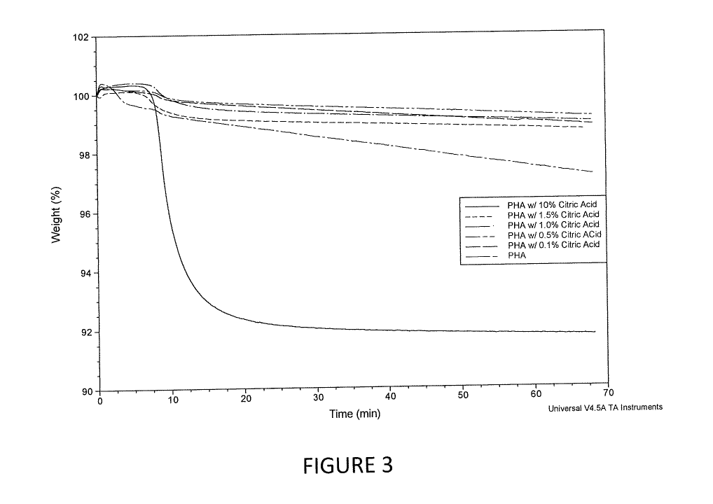

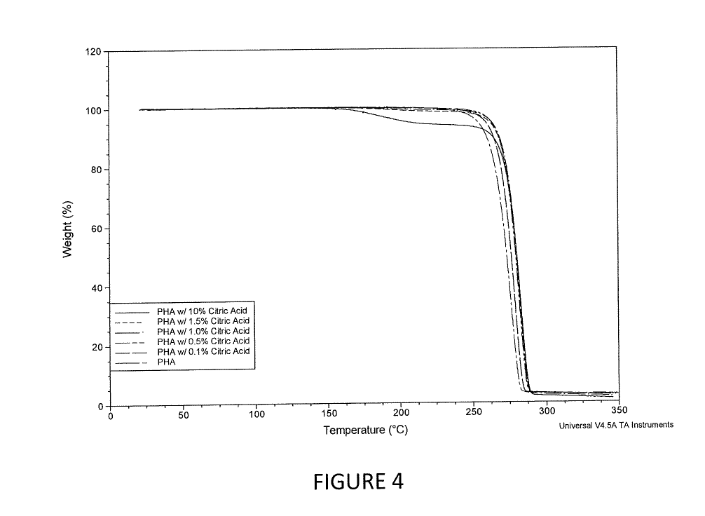

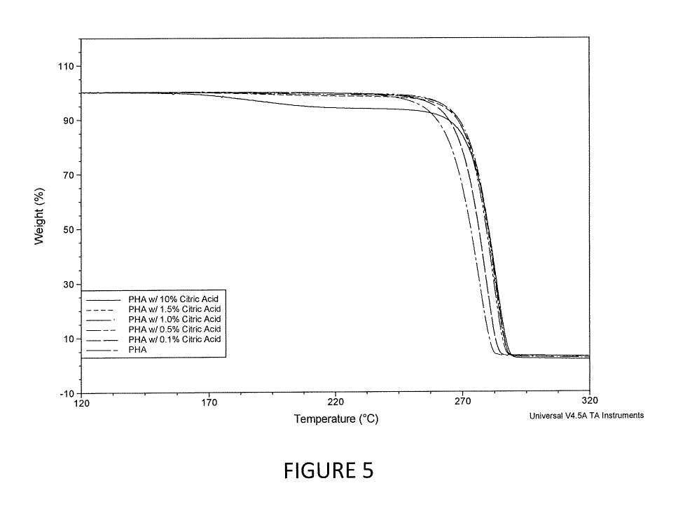

The chloroform was removed and the remaining solid was analyzed by TGA for the effect on thermal stability of the PHA. The samples were analyzed by TGA at 165° C. isothermal, at 185° C. isothermal and scanning temperature. FIG. 2 indicates that the isothermal TGA at 165° C. showed that 0.5% and 0.1% citric acid loading reduced weight loss as compared to the 0% loading at 60 minutes at temperature. FIG. 3 indicates that the isothermal TGA at 185° C. showed a marked difference with samples with 0.1-1.5% loading of citric acid and exhibited better thermal stability than the sample with 0% loading. Scanning TGA at 10° C./min (FIG. 4 and Table 2) shows improved thermal stability of PHA with the citric acid. FIG. 5 is the same as FIG. 4, but shows a smaller temperature range. The PHA sample with no citric acid had an onset of decomposition of 265° C. Onset of decomposition for all other samples was measured range between 269° C. at 0.1% citric acid to 273 for 10% citric acid. The 99% weight loss was improved with loadings of 0.1% and 0.5%. Samples with loadings of greater than 0.5% showed decreased 99% weight loss temperatures due to decomposition of citric acid. Improvements in the 95% weight loss temperatures were observed with all samples containing citric acid except at 10% loading. Again the high loading is lower due to the decomposition of citric acid. From these results, it can be concluded that all loadings from 0.1%-10% citric acid improve the thermal stability of PHA, and in one embodiment the optimum loading is in the range of 0.1% to 1.0% citric acid.

TABLE 2
Results of Scanning TGA (10° C./min) of
PHA with various Citric Acid Loadings.

| | Onset of decomposition | 99% Weight | 95% Weight |
|---|---|---|---|
| Sample | (extrapolated, ° C.) | Loss (° C.) | Loss (° C.) |
| PHA | 265 | 234 | 254 |
| PHA w/0.1% | 269 | 241 | 259 |
| citric acid | | | |
| PHA w/0.5% | 272 | 247 | 263 |
| citric acid | | | |
| PHA w/1.0% | 273 | 232 | 263 |
| citric acid | | | |
| PHA w/1.5% | 272 | 203 | 262 |
| citric acid | | | |
| PHA w/10.0% | 273 | 170 | 207 |
| citric acid | | | |

### Example 3

PHA is melt compounded with an acid having a pKa of 3-10. PHA powder or PHA pellets are mixed with citric acid (either neat or in solution) by mixing 99 parts PHA with 1 part citric acid in a vessel on a shaker or tumbler. The PHA mixed with the citric acid is extruded at 180° C. on an extruder configured for thermoplastic extrusion and pelletized.

The present invention has been described with reference to certain exemplary embodiments, compositions and uses thereof. However, it will be recognized by those of ordinary skill in the art that various substitutions, modifications or combinations of any of the exemplary embodiments may be made without departing from the spirit and scope of the invention. Thus, the invention is not limited by the description of the exemplary embodiment, but rather by the appended claims as originally filed.

1. A composition comprising:
a polyhydroxyalkanoate; and
an acid having a pKa of between 3-10;
wherein the acid is dispersed in the polyhydroxyalkanoate.

2. The composition of claim 1, wherein upon exposure of the composition to an increased temperature, the molecular weight of the polyhydroxyalkanoate in the composition decreases at a slower rate as compared to the polyhydroxyalkanoate without the acid dispersed therein.

3. The composition of claim 1, wherein the acid is selected from the group consisting of citric acid, polyacrylic acid, stearic acid, palmitic acid, lactic acid, a derivative of any thereof, and combinations of any thereof.

4. The composition of claim 1, wherein the acid is present in the composition at a level of between 0.01-10% by weight.

5. The composition of claim 1, wherein the acid is an organic acid.

6. The composition of claim 1, wherein the acid is citric acid.

7. The composition of claim 1, wherein the polyhydroxyalkanoate in the composition has an increased thermal stability as compared to polyhydroxyalkanoate without an acid dispersed therein.

8. A process for producing a product, comprising:
mixing as polyhydroxyalkanoate with an acid having as pKa of between 3-10.

9. The process of claim 8, wherein mixing the polyhydroxyalkanoate with the acid comprises homogenizing the polyhydroxyalkanoate with the acid.

10. The process of claim 8, wherein mixing the polyhydroxyalkanoate with the acid comprises mixing a powdered polyhydroxyalkanoate with the acid in a solvent such that the acid is homogenized with the powdered polyhydroxyalkanoate.

11. The process of claim 10, further nom wing the solvent.

12. The process of claim 8, further comprising casting a film comprising the acid and the polyhydroxyalkanoate.

13. The process of claim 8, wherein mixing the polyhydroxyalkanoate with the acid comprises melt compounding or melt extruding the polyhydroxyalkanoate and the acid at a temperature above the melting point of the polyhydroxyalkanoate.

14. The process of claim 8, further comprising forming the polyhydroxyalkanoate and the acid into a pellet or a powder.

15. A process for producing a product, comprising: injecting a melted polyhydroxyalkanoate homogenized with an acid into a mold; collecting an polyhydroxyalkanoate homogenized with the acid from outside the mold; and melting the collected polyhydroxyalkanoate homogenized with the acid.

16. The process of claim 15, wherein the acid has a pKa of between 3-10.

17. The process of claim 15, wherein the acid is citric acid.

18. A product produced by the process of claim 15 or claim 16.
